(19) United States
(12) Patent Application Publication
(10) Pub. No.: US 2026/0168187 A1
(43) Pub. Date: Jun. 18, 2026

(54) System and Method for Automatically Unbinding Moldboard and Antislab of Milling Machine

(71) Applicant: Caterpillar Paving Products Inc., Brooklyn Park, MN (US)

(72) Inventors: Paul J. Koenen, Andover, MN (US); Marcello Lirusso, Cambridge (CA); Timothy J. Sturos, Brooklyn Park, MN (US); Eric S. Engelmann, Delano, MN (US); Garrett D. Reed, Big Lake, MN (US)

(73) Assignee: Caterpillar Paving Products Inc., Brooklyn Park, MN (US)

(21) Appl. No.: 18/982,835

(22) Filed: Dec. 16, 2024

(51) Int. Cl. E01C 23/088; B02C 25/00; E01C 23/12

(52) U.S. Cl. CPC E01C 23/088; B02C 25/00; E01C 23/127

(57) ABSTRACT

A milling machine comprising includes a frame supported on at least one height-adjustable leg. A sensor is associated with the at least one leg and configured to obtain ground pressure information relating to a ground pressure generated by the at least one leg on a ground surface. The milling machine has a rotor chamber including a movable moldboard and a movable antislab. A controller is configured to determine, based on the ground pressure information, whether the ground pressure generated by the at least one leg is less than a predetermined value indicating a binding event. The controller is configured to automatically raise or pulse, based on the determination that the ground pressure generated by the at least one leg is less than a predetermined value, at least one of the moldboard and the antislab to relieve the binding event.

### TECHNICAL FIELD

This patent disclosure relates generally to a milling machine and, more particularly, to a system for automatically unbinding the moldboard and/or antislab of a milling machine upon detection of a binding condition.

### BACKGROUND

Milling machines are typically used to remove a layer or layers of ground surface or old or defective road surface in preparation for road formation or resurfacing. To this end, milling machines typically include a milling rotor having rotor bits for breaking up the ground surface. A rotor chamber surrounds the rotor and helps direct the milled material toward a conveyor or back toward the ground or road surface. Such rotor chambers may include vertically movable chamber walls that surround the rotor and float along the ground surface during the milling operation. Thus, as the milling machine (and rotor) engages the ground, the movable walls can be urged upward by the ground surface. This forward end of this chamber may include an anti-slab that slides over the unmilled portion of the ground surface to prevent large slabs from breaking off as the ground surface is milled. The rearward end of the chamber may include a moldboard that may help remove any loose aggregate or debris that has not been captured by the milling rotor assembly. A typical milling machine is supported on tracks or wheels that are coupled to a frame by legs that may extend or retract to lift or lower the frame of the machine relative to the ground surface.

Some milling machines include an automatic grade control system in which the milling machine automatically adjusts to achieve milling to a target depth. During automatic grade control mode, the milling machine senses its position in relation to the target depth and automatically extends or retracts the legs to adjust the position of the milling rotor to the target depth. For example, if the milling machine is not cutting deep enough to reach the target depth, the automatic grade control will retract the legs to lower the rotor until it reaches the target depth. However, if either the moldboard or the antislab bind on the ground or road surface, the milling rotor may not be able to achieve the target depth. In such a scenario, the automatic grade control system will still try to retract the front legs of the machine to lower the milling rotor. This can cause the hydraulic pressure in one or more of the cylinders controlling the front legs of the milling machine to become very low which, in turn, may lead to the front ground engaging members producing minimal ground pressure or even lifting off the ground. This can adversely impact propulsion as well as grading performance of the milling machine.

U.S. Pat. No. 5,318,378, assigned to the assignee of the present disclosure, discloses a system for monitoring pressure to detect a kickback event in operation of a milling machine and, in response, shuts off the milling rotor. However, the system of U.S. Pat. No. 5,318,378 does not take any action to eliminate the operating condition that caused the kickback. GB 2603949 discloses a system method and system for controlling the height of a milling machine that compares pressures in the milling machine legs to maintain load balancing but does not provide for adjustment of the moldboard or antislab to unbind the milling machine.

### SUMMARY

The disclosure describes, in one aspect, a milling machine including a frame supported on at least one height-adjustable front leg and at least one rear leg. A sensor is associated with the at least one leg and is configured to obtain ground pressure information relating to a ground pressure generated by the at least one leg on a ground surface. The milling machine further includes a rotor and a rotor chamber including a movable moldboard and a movable antislab. A controller is configured to determine, based on the ground pressure information, whether the ground pressure generated by the at least one leg is less than a predetermined value indicating a binding event. The controller is configured to automatically raise or pulse, based on the determination that the ground pressure generated by the at least one leg is less than a predetermined value, at least one of the moldboard and the antislab to relieve the binding event.

In another aspect, the disclosure describes a method of operating a milling machine having a frame supported on at least one height-adjustable front leg, a rotor and a rotor chamber including a movable moldboard and a movable antislab. The method includes obtaining ground pressure information relating to a ground pressure generated by the at least one leg on a ground surface. The method includes determining, based on the ground pressure information, whether the ground pressure generated by the at least one leg is less than a predetermined value indicating a binding event. The method includes automatically raising or pulsing, based on the determination that the ground pressure generated by the at least one leg is less than a predetermined value, at least one of the moldboard and the antislab to relieve the binding event.

In yet another aspect, the disclosure describes a binding control system for a milling machine having a frame supported on at least one height-adjustable front leg, a rotor and a rotor chamber including a movable moldboard and a movable antislab. The binding control system includes a sensor associated with the at least one leg and configured to obtain ground pressure information relating to a ground pressure generated by the at least one leg on a ground surface. A controller is configured to determine, based on the ground pressure information, whether the ground pressure generated by the at least one leg is less than a predetermined value indicating a binding event. The controller is configured to automatically raise or pulse, based on the determination that the ground pressure generated by the at least one leg is less than a predetermined value, at least one of the moldboard and the antislab to relieve the binding event.

### BRIEF DESCRIPTION OF THE DRAWINGS

FIG. 1 is a side elevation view of an exemplary milling machine according to the present disclosure.

FIG. 2 is a partially schematic diagram of the rotor chamber and front legs of the milling machine of FIG. 1.

FIG. 3 is a diagram of an exemplary binding control system for the milling machine of FIG. 1.

FIG. 4 is a flow chart illustrating an exemplary process that is executable by the binding control system of FIG. 3.

### DETAILED DESCRIPTION

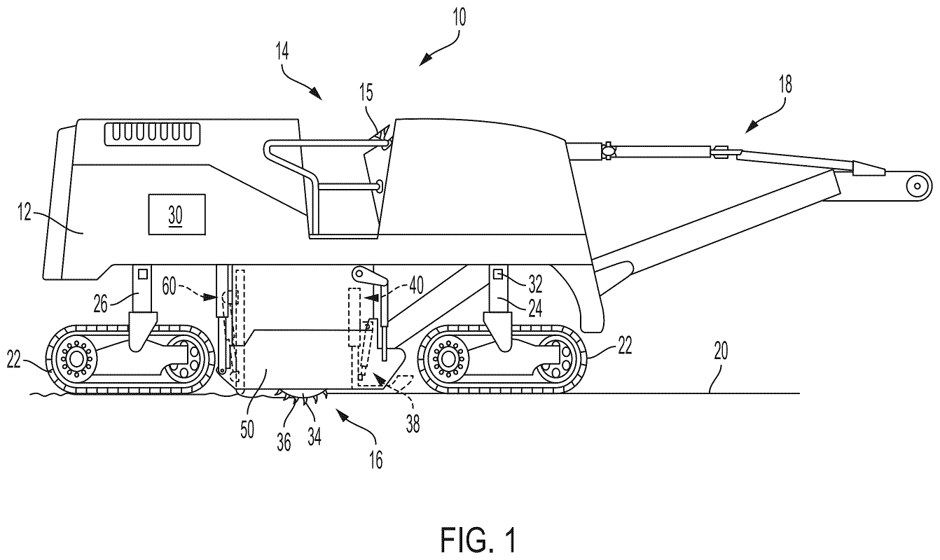

Now referring to the drawings, wherein whenever possible like reference numbers will refer to like elements, FIG. 1 illustrates an exemplary milling machine 10, such as a cold planer machine, according to the present disclosure. The illustrated milling machine 10 may be operable to remove one or more layers of material from a ground surface 20. For the purpose of this disclosure, the term “ground surface” is broadly used to refer to all types of surfaces that form typical roadways (e.g., asphalt, cement, clay, sand, dirt, etc.) or can be milled in the removal or formation of roadways. Moreover, the current disclosure is described with reference to a milling machine 10. As used herein, a milling machine includes any machine that includes a ground engaging rotor or cutter to displace ground surfaces. Examples of such milling machines include cold planers and ground reclaimers.

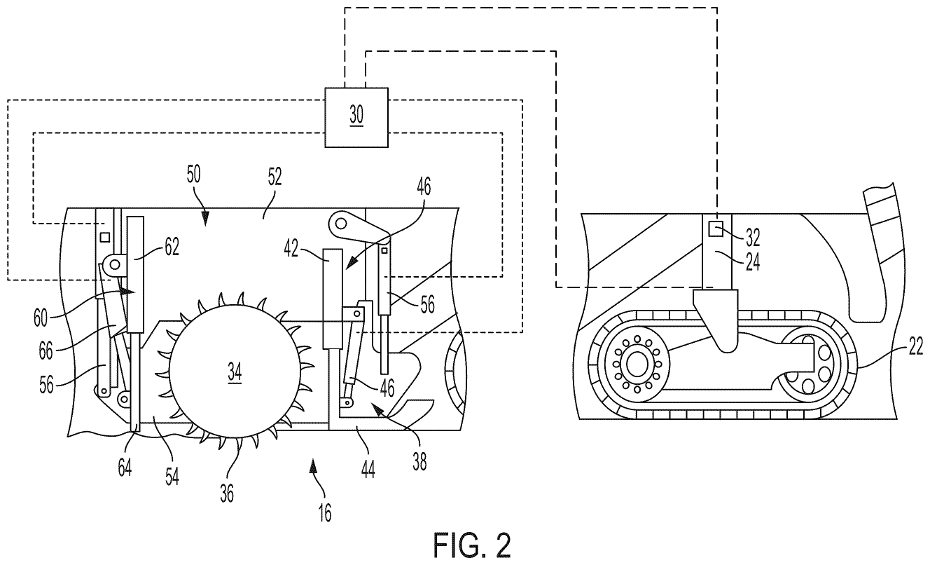

Again, with reference to FIG. 1, the illustrated milling machine 10 includes a frame 12 supporting an operator station 14, and a milling assembly 16 coupled to an underside of the frame 12. The operator station 14 may include one or more user interface devices, such as a display 15 for monitoring and controlling the milling machine 10. The milling machine 10 may also include a front-located conveyor assembly 18 configured to advance milled material from milling assembly 16 away from the ground surface 20, for example, to be deposited into a bed of a truck (not shown). The milling machine 10 includes a plurality of ground engaging devices 22 configured to move the milling machine over the ground device. The ground engaging devices 22 in this case are endless tracks that are coupled to the frame 12 via pairs of front and rear height-adjustable legs 24, 26, each of which may comprise an independent hydraulic actuator, to provide for raising and lowering of the milling machine 10 (only a single front leg 24 and a single rear leg 26 are shown in the side view of FIG. 1). The milling machine 10 may further include one or more controllers 30 sending and receiving signals for monitoring and controlling the operation of the milling machine 10. For example, the height of the front legs 24 may be controlled in any appropriate manner by the controller 30 (as shown by dashed lines in FIG. 2) and appropriate signals and hydraulic circuits.

Each of the front legs 24 may be equipped with a front leg sensor 32 (see FIG. 2) that is configured to obtain information from which a light leg condition of the respective front leg 24 may be determined. In a light leg condition, the respective front leg 24 is generating ground pressure on the ground surface 20 below a minimum threshold or a ground pressure within a predetermined range. According to one embodiment, the front leg sensor 32 may be a pressure sensor. For example, the front leg sensor 32 may be configured to obtain information indicative of head pressure, rod pressure or a difference between the head pressure and rod pressure of the hydraulic actuator of the respective front leg 24. According to another embodiment, the front leg sensor 32 may measure strain on the respective front leg 24. It will be appreciated that other types of sensors also may be employed on or in relation to the front legs 24 of the milling machine 10 and from which information indicative of the ground pressure produced by the respective front leg 24 may be obtained. Moreover, although in FIG. 2 the front leg sensor 32 is illustrated as a single, discrete unit, the respective sensor functions may be distributed among a plurality of distinct and separate sensor elements.

The front leg sensors 32 may be arranged and configured to send signals to the controller 30 (shown connected to the controller 30 by dashed lines in FIG. 2) indicative of the ground pressure being generated by the respective front leg 24. From this information, the controller 30 may determine if the ground pressure exerted by the respective front leg 24 is below a predetermined threshold value or is within a predetermined range that indicates a light leg condition. For example, if the front leg sensor 32 is a pressure sensor, the controller 30 may determine whether the pressure in the head end of the leg actuator has fallen below a threshold value or is within a predetermined range. Alternatively, if the front leg sensor 32 is configured to provide signals indicative of a pressure difference between the head and rod end of the actuator of the front leg 24, the controller 30 may be configured to determine whether this pressure difference has fallen below a predetermined threshold value or is in a predetermined range of values. In some embodiments, the sensors 32 may alternatively be provided on one or more of the rear legs 26 of the milling machine. Sensors 32 may also be provided on at least one front leg 24 and at least one rear leg 26.

Referring to FIGS. 1 and 2, the milling assembly 16 may include a ground-engaging rotor 34 having rotor bits 36. The rotor 34 may be enclosed within a series of walls forming a rotor chamber 38. The walls of the rotor chamber 38 may include a movable front wall 40, a pair of movable side walls 50 (only one shown in FIG. 1), and a movable rear wall 60 at the rear of the rotor chamber 38. During operation, as the rotor 34 rotates in the ground surface 20, the walls (40, 50, 60) of the rotor chamber 38 ride along the ground surface 20 and form a barrier that retains much of the milled material, and urges the milled material toward the conveyor assembly 18.

Referring to FIG. 2, movable front wall 40 may include an upper support wall 42, a lower movable antislab 44, and one or more antislab actuators 46 coupled between the upper support wall 42 and antislab 44 for controllably moving the antislab 44 vertically. Similarly, movable side walls 50 may include an upper support wall 52, a movable lower wall 54, and one or more side wall actuators 56 coupled between the upper support wall 52 and the lower wall 54 for controllably moving the lower side walls 54. Movable rear wall 60 may include an upper support wall 62, a lower movable moldboard 64 and one or more moldboard actuators 66 coupled between the upper support wall 62 and the moldboard 64 for controllably moving the moldboard 64 vertically. The antislab actuators 46, the side wall actuators 56, and moldboard actuators 66 of the rotor chamber 38 may be any type of actuator, for example hydraulic actuators. While only one actuator is shown for each of the movable lower side walls 54, antislab 44, and moldboard 64, it is understood that more than one actuator may be used for each wall. As generally shown by the dashed lines in FIG. 2, the antislab actuators 46, side wall actuators 56, and moldboard actuators 66 may be controlled in any appropriate manner, such as by the controller 30 and appropriate signals and hydraulic circuits. Further, the antislab actuators 46, the moldboard actuators 66, and the side wall actuators 56 may include position sensors or detectors for providing information to the controller 30 relating to the positions of the antislab 44, moldboard 64 and side walls 54.

To help provide accurate control of the grading depth during operation of the milling machine, the controller 30 may be configured to monitor and automatically adjust the milling machine 10 to achieve milling by the rotor 34 to a target depth. This may be referred to as an automatic grade control mode of operation of the milling machine. In automatic grade control mode, the controller 30 may adjust the height of the front legs 24 of the milling machine 10 so as to automatically keep the rotor 34 cutting to the desired depth without the need for any operator intervention. For example, if the controller 30 determines that the milling machine 10 is not reaching the target depth, the controller 30 in automatic grade control mode may lower the height of the front legs 24 thereby lowering the rotor 34 relative to the ground surface 20 until the milling machine 10 is again achieving milling to the target depth. Similarly, if the controller 30 determines that the milling machine 10 is milling to a depth lower than the target depth, the controller 30 may raise the height of the front legs 24 until the rotor 34 is again cutting to the target depth. In other embodiments, the controller 30 may adjust the height of the rear legs 26 to adjust the cutting depth of the rotor 34.

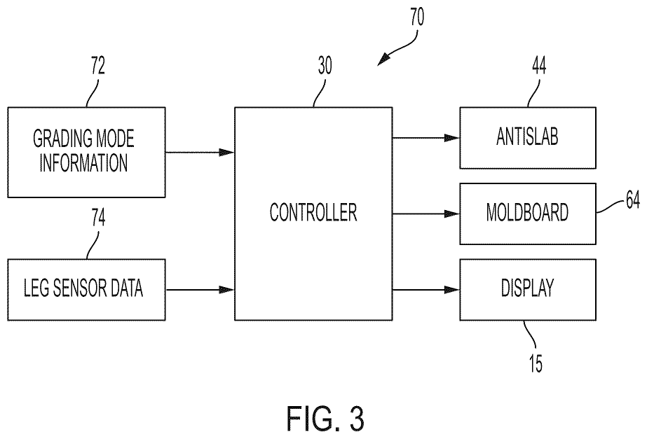

An exemplary binding control system 70 according to the present disclosure is shown schematically in FIG. 3. The binding control system 70 may be operable during automatic grade control mode of the milling machine 10 and be configured to both detect a binding condition during operation of the milling machine and to take action to correct the binding condition. To this end the controller 30 may receive automatic grade control information 72 indicative of whether the automatic grade control mode is engaged. For example, this information may relate to whether the automatic grade control mode has been actuated by an operator of the milling machine 10. This information may be determined internally of the controller 30. As part of the binding control system, the controller 30 may also receive leg sensor data 74 such as from front leg sensor 32 as discussed above. The controller 30 may use the leg sensor data 74 to determine if a light leg condition exists in one or more of the front or rear legs 24, 26 of the milling machine 10. This determination may be based on whether the ground pressure of the respective front or rear leg 24, 26 has dropped below a threshold value or into a predetermined range. In some embodiments, this threshold value or predetermined range is set at a level at which the front leg 24 is approaching, but not yet experiencing, a light leg condition.

As part of the binding control system 70, the controller 30 may also send signals to various components of the milling machine 10. For example, controller 30 may send signals to control various aspects of the milling machine 10, including movement of the moldboard 64 and the antislab 44. For example, controller 30 may send signals to control the moldboard actuators 66 and/or antislab actuators 46. In some embodiments, this movement may include a raising and/or pulsing raising and lowering of the moldboard 64 or antislab 44. The controller 30 may also send signals to control display 15, for example, to notify an operator of a binding condition.

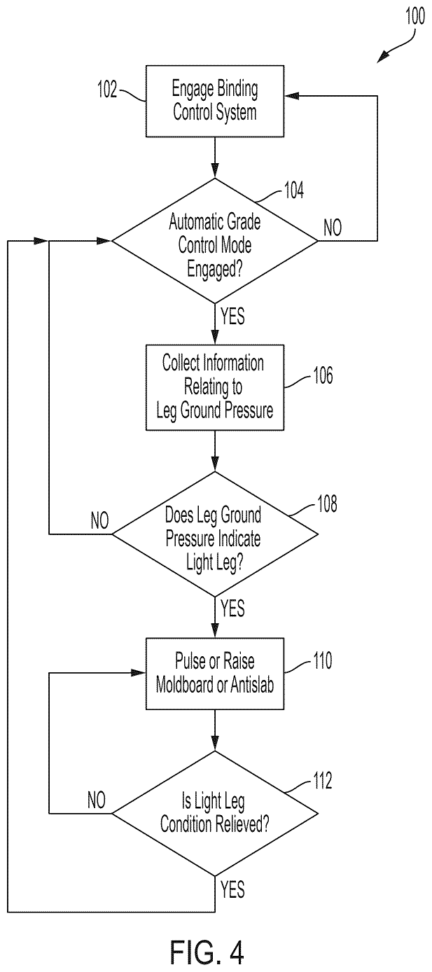

The controller 30 may be in any conventional form and may include, for example, hardware, software, and firmware for executing various instructions or functions, including those described in connection with the method of FIG. 4. For example, controller 30 may include one or more processors, memory, communication systems, clocks, and/or other appropriate hardware. Controller 30 may be, for example, a single or multi-core processor, a digital signal processor, microcontroller, a general purpose central processing unit (CPU), and/or other conventional processor or processing/controlling circuit or controller. The memory may include, for example, read-only memory (ROM), random access memory (RAM), flash or other removable memory, or any other appropriate and conventional memory. Although in FIGS. 2-3, the controller 30 is illustrated as a single, discrete unit, in other embodiments, the controller 30 and its functions may be distributed among a plurality of distinct and separate components, including various components and functionalities located onboard the milling machine 10 and/or at an off-board operator station. Communication systems associated with controller 30 (e.g., between controller 30 and various components of machine 10 including the one or more front leg sensors 32) may include, for example, any conventional wired and/or wireless communication systems such as Ethernet, Bluetooth, and/or wireless local area network (WLAN) type systems.

### INDUSTRIAL APPLICABILITY

The present disclosure is applicable to any milling machine that may have a moldboard or antislab that is susceptible to binding on the ground surface when operating in automatic grade control mode. More specifically, the disclosed systems and methods may help detect and alleviate binding conditions of the moldboard or antislab that cause a light front leg condition that, if not corrected, can lead to inefficient operation of the binding machine.

Referring to FIG. 4, and in general accordance with the prior figures, there is illustrated an exemplary process 100 for detecting and resolving a binding condition of the milling machine 10 that may be executed by the controller 30 and the binding control system 70. The process depicted in the flow diagram of FIG. 4 for accomplishing these tasks may include a series of steps or instruction implemented as non-transitory computer executable software code in the form of an application or program that is run by the controller 30. In step 102 of the process, the binding control system 70 is engaged. The binding control system may be engaged automatically by the controller 30 upon engagement of the automatic grade control mode. In other embodiments, the binding control system 70 may be engaged by an operator of the milling machine 10.

In step 104 of the illustrated process, the controller 30 determines if the automatic grade control mode is engaged. If the automatic grade control system is not engaged, the process returns to the beginning and no further steps of the process are undertaken until the automatic grade control system is engaged. In other embodiments, the following steps could be executed by the binding control system 70 and controller 30 even when the milling machine 10 is not in automatic grade control mode, such as when an operator is manually controlling the grading depth. In other embodiments, it may be desirable to disengage the binding control system 70 during maintenance operations in which the front legs 24 or rear legs 26 may be raised while servicing the milling machine 10.

Step 106 of the process, the controller 30 collects information relating to leg ground pressure. As discussed above, this information may be communicated to the controller 30 by one or more of the leg sensors 32. In this respect, the information may relate to one or both of the front legs 24 and/or one or both of the rear legs 26. In step 108, the controller 30 determines whether the leg ground pressure indicates a light leg condition. This determination may be made when the ground pressure falls below a certain threshold value or when the ground pressure falls into a predetermined range. The threshold value or predetermined range of leg ground pressure may be set so that a light leg condition is indicated when the ground pressure is approaching an actual light leg situation. As will be understood, the threshold value or predetermined range of leg ground pressure used by the controller 30 in step 108 may vary based on several factors including the size and configuration of the milling machine 10 and the particular operation being performed by the milling machine 10. If a light leg condition is not indicated in step 108, the illustrated process returns to step 104 and steps 104, 106 and 108 are repeated.

If a light leg condition is indicated in step 108, this signifies that the moldboard 64 and/or antislab 44 is binding and the process moves to step 110 where the controller 30 attempts to correct the binding condition. More specifically, in step 110 the controller 30 pulses and/or raises the moldboard 64 or antislab 44 in order to alleviate the binding condition. Whether the binding event is being caused by the moldboard 64 or the antislab 44 may be determined by controller 30 via the ground pressure information from the front leg sensors 32. If it is determined that the binding event is being caused by one of the moldboard 64 or antislab 44, then the controller 30 can raise or pulse just the bound component. In other circumstances or embodiments, the controller 30 in step 110 could raise or pulse both moldboard 64 and antislab 44. In some embodiments, position sensors on the moldboard 64 and/or the antislab 44 may be used to determine if it is the moldboard 64, antislab 44 or both that is causing the binding condition. In some embodiments, the antislab 44 is more likely to bind when the milling machine 10 is being propelled along a surface. In such a case, the controller 30 may first raise and/or pulse the antislab 44 when a light leg condition is indicated and the milling machine 10 is moving. In some embodiments, either the moldboard 64 or antislab 44 may bind when the milling machine 10 is executing a stationary plunge. In that case, the controller 44 may raise and/or pulse both the moldboard 64 and antislab 44 when a light leg condition is indicated during a stationary milling operation.

The action taken by controller 30 in step 10 to correct the binding condition may comprise raising or pulsing of the moldboard 64 and/or antislab 44 through actuation of the corresponding moldboard and antislab actuators 66, 46. The pulsing can vary in duration and amplitude (i.e. the distance the moldboard and/or actuator is raised and lowered). In one example, the controller 30 directs the appropriate actuator to lift and then float down the moldboard 64 or the antislab 44. In another example, the controller 30 may direct the moldboard and/or antislab actuators 66, 46 to first push down the moldboard 64 and/or antislab 44 and then relieve pressure to return to the moldboard 64 and/or antislab 44 to a float condition. Further, in attempting to relieve the binding condition, the controller 30 could pulse one or more of the moldboard actuators 66 and/or one or both of the antislab actuators 46 (e.g., one or both sides).

In step 112, the controller 30 determines if the light leg condition still exists. Again, this may be determined using ground pressure information from the front leg sensors 32. If the light leg condition still exists, this indicates that the moldboard 64 and/or antislab 44 is still binding and step 108 is repeated until the leg ground pressure is no longer in the predetermined range or below the threshold value. If it is determined that the light leg condition has been alleviated, this indicates that the binding condition has been corrected and the illustrated process returns to step 104 and is repeated in order to continue to monitor and correct binding conditions.

As part of the process 100, the controller 30 may also send a binding notification or alarm to an operator of the milling machine 10 and/or a remote monitoring location when a light leg condition is detected. The binding notification may be communicated to the operator via the display 15. In other embodiments, the binding notification may be communicated via an alarm that is separate from the machine display. The controller 30 also could send an alarm signal or otherwise notify the operator when the pulsing of the moldboard 64 or antislab 44 starts. The alarm may be visual and/or audible.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or “one or more of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A milling machine comprising:
a frame supported on at least one height-adjustable leg;
a sensor associated with the at least one leg and configured to obtain ground pressure information relating to a ground pressure generated by the at least one leg on a ground surface;
a rotor;
a rotor chamber including a movable moldboard and a movable antislab; and
a controller configured to:
determine, based on the ground pressure information, whether the ground pressure generated by the at least one leg is less than a predetermined value indicating a binding event; and
automatically raise or pulse, based on the determination that the ground pressure generated by the at least one leg is less than a predetermined value, at least one of the moldboard and the antislab to relieve the binding event.

2. The milling machine of claim 1, wherein, in an engageable automatic grade control mode, the controller is configured to automatically control a milling a depth of the rotor by adjusting a height of the at least one leg.

3. The milling machine of claim 2, wherein the controller is configured to raise or pulse at least one of the moldboard and antislab to relieve a binding event only when the automatic grade control mode is engaged.

4. The milling machine of claim 1, wherein, after automatically raising or pulsing at least one of the moldboard and the antislab, the controller is configured to determine, based on the ground pressure information, whether the ground pressure generated by the at least one leg is greater than the predetermined value.

5. The milling machine of claim 4, wherein, when the ground pressure is lower than the predetermined value after raising or pulsing of at least one of the moldboard and the antislab, the controller is configured to repeat the step of raising or pulsing of the at least one of the moldboard and the antislab.

6. The milling machine of claim 1, wherein the sensor is configured to obtain hydraulic fluid pressure information relating to the at least one leg.

7. The milling machine of claim 1, wherein the sensor is configured to obtain pressure information relating to difference between a head end hydraulic fluid pressure and a rod end hydraulic fluid pressure of the at least one leg.

8. The milling machine of claim 1, wherein the controller is configured to determined, based on the ground pressure information, whether the binding event is being caused by the moldboard or the antislab.

9. The milling machine of claim 1, wherein the controller is configured such that, when the controller determines that the binding event is being caused by the moldboard, the controller automatically raises or pulses only the moldboard.

10. The milling machine of claim 1, wherein the controller is configured such that, when the controller determines that the binding event is being caused by the antislab, the controller automatically raises or pulses only the antislab.

11. A method of operating a milling machine having a frame supported on at least one height-adjustable leg, a rotor and a rotor chamber including a movable moldboard and a movable antislab, the method comprising:
obtaining ground pressure information relating to a ground pressure generated by the at least one leg on a ground surface;
determining, based on the ground pressure information, whether the ground pressure generated by the at least one leg is less than a predetermined value indicating a binding event; and
automatically raising or pulsing, based on the determination that the ground pressure generated by the at least one leg is less than a predetermined value, at least one of the moldboard and the antislab to relieve the binding event.

12. The method of claim 11, further including the step of automatically controlling, in an engageable automatic grade control mode, a milling a depth of the rotor by adjusting a height of the at least one leg.

13. The method of claim 12, where in the step of raising or pulsing the at least one of the moldboard and antislab to relieve the binding event is only performed when the automatic grade control mode is engaged.

14. The method of claim 11, wherein after the step of after automatically raising or pulsing at least one of the moldboard and the antislab, further including the step of determining, based on the ground pressure information, whether the ground pressure generated by the at least one leg is greater than the predetermined value.

15. The method of claim 14, further including the step of repeating the step of raising or pulsing the at least one of the moldboard or antislab when the ground pressure is lower than the predetermined value after raising or pulsing of at least one of the moldboard and the antislab.

16. The method of claim 11, further including the step of determining, based on the ground pressure information, whether the binding event is being caused by the moldboard or the antislab and automatically raising or pulsing only the moldboard when it is determined that the binding event is being caused by the moldboard and automatically raising or pulsing only the antislab when it is determined that the binding event is being caused by the antislab.

17. A binding control system for a milling machine having a frame supported on at least one height-adjustable leg, a rotor and a rotor chamber including a movable moldboard and a movable antislab, the binding control system comprising:
a sensor associated with the at least one leg and configured to obtain ground pressure information relating to a ground pressure generated by the at least one leg on a ground surface; and
a controller configured to:
determine, based on the ground pressure information, whether the ground pressure generated by the at least one leg is less than a predetermined value indicating a binding event; and
automatically raise or pulse, based on the determination that the ground pressure generated by the at least one leg is less than a predetermined value, at least one of the moldboard and the antislab to relieve the binding event.

18. The binding control system of claim 17, wherein, in an engageable automatic grade control mode, the controller is configured to automatically control a milling a depth of the rotor by adjusting a height of the at least one leg and wherein the controller is configured to raise or pulse at least one of the moldboard and antislab to relieve a binding event only when the automatic grade control mode is engaged.

19. The binding control system of claim 17 wherein the controller is configured to determined, based on the ground pressure information, whether the binding event is being caused by the moldboard or the antislab and wherein the controller is configured such that, when the controller determines that the binding event is being caused by the moldboard, the controller automatically raises or pulses only the moldboard and, when the controller determines that the binding event is being caused by the antislab, the controller automatically raises or pulses only the antislab.

20. The binding control system of claim 17 wherein, after automatically raising or pulsing at least one of the moldboard and the antislab, the controller is configured to determine, based on the ground pressure information, whether the ground pressure generated by the at least one leg is greater than the predetermined value and wherein, when the ground pressure is lower than the predetermined value after raising or pulsing of at least one of the moldboard and the antislab, the controller is configured to repeat the step of raising or pulsing of the at least one of the moldboard or antislab.
